(19) United States
(12) Patent Application Publication
(10) Pub. No.: US 2026/0269278 A1
(43) Pub. Date: Sep. 10, 2026

(54) CATALYST LAYER FOR FUEL CELL

(71) Applicant: TOYOTA JIDOSHA KABUSHIKI KAISHA, Toyota-shi (JP)

(72) Inventor: Nobuaki MIZUTANI, Toyota-shi (JP)

(73) Assignee: TOYOTA JIDOSHA KABUSHIKI KAISHA, Toyota-shi (JP)

(21) Appl. No.: 19/539,409

(22) Filed: Feb. 13, 2026

(30) Foreign Application Priority Data
Mar. 7, 2025 (JP) 2025-036014

(51) Int. Cl. H01M 4/92; H01M 4/86; H01M 4/88; H01M 4/90; H01M 8/02; H01M 8/10; H01M 8/1004

(52) U.S. Cl. CPC H01M 4/925; H01M 4/8605; H01M 4/881; H01M 4/9083; H01M 4/92; H01M 4/921; H01M 4/926; H01M 8/02; H01M 8/1004; H01M 2008/1095

(57) ABSTRACT

The catalyst layer for a fuel cell includes at least a base material, a carbon support, and a catalyst metal. A specific surface area of the carbon support is 1000 to 1500 m²/g. The thickness loss rate A of the catalyst layer represented by the expression (I) is 45% or less. The deformation rate B of the catalyst layer represented by the expression (II) is 50% or less.

$$A = ( 1 - {T}_{1} / {T}_{0} ) \times 100 \qquad ( I )$$

$$B = {D}_{i} / {T}_{0} \times 100 \qquad ( II )$$

T₀ is an initial thickness of the catalyst layer. T₁ is a thickness of the catalyst layer after a durability treatment. Dᵢ is a deformation amount obtained as an inflection point of a load variation curve obtained by a micro-burst test of the catalyst layer. The durability treatment is performed under conditions described in the specification or the claims.

### CROSS-REFERENCE TO RELATED APPLICATION

This application claims priority to Japanese Patent Application No. 2025-036014 filed on Mar. 7, 2025. The disclosure of the above-identified application, including the specification, drawings, and claims, is incorporated by reference herein in its entirety.

### BACKGROUND

### 1. Technical Field

The present disclosure relates to a catalyst layer for a fuel cell.

### 2. Description of Related Art

In the fuel cell, hydrogen and oxygen are electrochemically reacted to obtain electric power. The product generated in the power generation of the fuel cell is only water in principle. Therefore, it has attracted attention as a clean power generation system with almost no burden on the earth environment. The fuel cell is configured with a membrane electrode assembly (hereinafter, also referred to as “MEA”) in which a catalyst layer is disposed on both surfaces of an electrolyte membrane and a gas diffusion layer is disposed on the outer side of each catalyst layer, as a basic unit. A polymer electrolyte (hereinafter, also referred to as “ionomer”) having an ion exchange group is usually used as a binder of the electrolyte membrane and the catalyst layer. During the operation of the fuel cell, a fuel gas containing hydrogen is supplied to the catalyst layer on the anode (fuel electrode) side, and an oxidizing gas containing oxygen is supplied to the catalyst layer on the cathode (air electrode) side, to obtain an electromotive force. In the anode, an oxidation reaction of hydrogen proceeds, and in the cathode, a reduction reaction of oxygen proceeds, to supply the electromotive force to the external circuit. Various catalyst layers that can be used in the fuel cell and methods of manufacturing the same have been developed.

For example, Japanese Unexamined Patent Application Publication No. 2022-71293 (JP 2022-71293 A) discloses a fuel cell having the following features. The fuel cell includes an anode-side gas diffusion layer, an anode catalyst layer, an electrolyte membrane, a cathode catalyst layer, and a cathode-side gas diffusion layer in this order. The cathode catalyst layer includes a catalyst-supported support on which a catalyst is supported, and a proton-conductive resin. A mass ratio (I/C) of the proton-conductive resin to the catalyst-supported support in the cathode catalyst layer is 0.95 or more and 1.8 or less. An equivalent weight ratio (EW) of the proton-conductive resin is 650 or more. A specific surface area of the catalyst-supported support is 1300 m²/g or more. A water absorption rate of the electrolyte membrane is 70% or less. A water absorption rate of the cathode catalyst layer is 30% or more and 200% or less.

### SUMMARY

As described above, water is generated during the operation of the fuel cell. In an environment in which water is present in this way, in a case where a carbon support is used in a cathode electrode catalyst layer of the fuel cell, the carbon support is oxidized, and the carbon support is deteriorated. In a case where the carbon support is deteriorated in the cathode electrode catalyst layer, there is a problem that the void of the carbon support for the diffusion of the oxygen gas is closed, and the power generation performance is deteriorated.

The oxidation of the carbon support as described above may increase in frequency in proportion to the specific surface area of the carbon support. Therefore, the oxidation of the carbon support can be suppressed by reducing the specific surface area of the carbon support. However, in a case where the carbon support having a low specific surface area is used, there is a problem that the power generation performance of the catalyst layer including the carbon support is low in the initial stage.

Therefore, an object of the present disclosure is to provide an electrode catalyst layer for a fuel cell that has high power generation performance not only initially but also after long-term operation.

The present inventors have variously studied means for solving the problem. The present inventors have found the following findings. In the catalyst layer for a fuel cell having a carbon support on which a catalyst metal is supported, a carbon support having a high specific surface area is used, and a thickness loss rate and a deformation rate of the catalyst layer before and after a durability treatment are within a predetermined range. As a result, not only is the initial voltage of the fuel cell obtained improved, but also the decrease in voltage after the durability treatment is suppressed. The present inventors have completed the present disclosure based on the above findings.

That is, the present disclosure includes the following aspects and embodiments.

Embodiment 1: A catalyst layer for a fuel cell, the catalyst layer including at least:
a base material;
a carbon support disposed on a surface of the base material; and
a catalyst metal supported on the carbon support.

In the catalyst layer for a fuel cell, a specific surface area of the carbon support is in a range of 1,000 m²/g to 1,500 m²/g,
a thickness loss rate A (%) of the catalyst layer represented by the following expression (I) is 45% or less, and
a deformation rate B (%) of the catalyst layer represented by the following expression (II) is 50% or less.

$$A ( \% ) = ( 1 - {T}_{1} / {T}_{0} ) \times ( 100 ) \qquad ( I )$$

$$B ( \% ) = {D}_{i} / {T}_{0} \times 100 \qquad ( II )$$

In the expression (I) and the expression (II),
T₀ is an initial thickness (μm) of the catalyst layer,
T₁ is a thickness (μm) of the catalyst layer after a durability treatment,
Dᵢ is a deformation amount (μm) obtained as an inflection point of a load variation curve obtained by a micro-burst test of the catalyst layer, and
the durability treatment is performed by producing a membrane electrode assembly in which
the catalyst layer is used as either or both of a cathode and an anode, and performing, using
the membrane electrode assembly as a single cell, a steady operation at 1 V to 1.5 V for 1 hour to 5 hours under conditions of a constant flow rate of H2/N₂ gas, a cell temperature of 70° C. to 90° C., an anode (hydrogen) dew point of 70° C. to 90° C., a cathode (air) dew point of 70° C. to 90° C., and a back pressure of 50 kPa to 150 kPa (absolute value).

Embodiment 2: The catalyst layer according to Embodiment 1, in which the thickness loss rate A (%) of the catalyst layer is in a range of 20% to 45%.

Embodiment 3: The catalyst layer according to Embodiment 1 or 2, in which the deformation rate B (%) of the catalyst layer is in a range of 20% to 50%.

Embodiment 4: The catalyst layer according to any one of Embodiments 1 to 3, in which the thickness loss rate A (%) of the catalyst layer is in a range of 27% to 42%, and the deformation rate B (%) of the catalyst layer is in a range of 24% to 47%.

Embodiment 5: The catalyst layer according to any one of Embodiments 1 to 4, in which the specific surface area of the carbon support is in a range of 1,000 m²/g to 1,280 m²/g.

According to the present disclosure, it is possible to provide an electrode catalyst layer for a fuel cell that has high power generation performance not only initially but also after long-term operation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing a relationship between a thickness loss rate of a catalyst layer of Comparative Examples 1, 2, and 5 and a voltage of a membrane electrode assembly (MEA) having the catalyst layer after a durability treatment at a high current density;

FIG. 2 is a graph showing a relationship between a deformation rate of a catalyst layer of Comparative Examples 3, 4, and 5 and an initial voltage of an MEA having the catalyst layer at a high current density;

FIG. 3 is a graph showing a relationship between a deformation rate and a thickness loss rate of the catalyst layer of Comparative Examples 1 to 8 and Embodiments 1 to 8; and

FIG. 4 is a graph showing a relationship between an initial voltage and a voltage after the durability treatment at a high current density of an MEA having the catalyst layer of Comparative Examples 1 to 8 and Embodiments 1 to 8 at a high current density.

### DETAILED DESCRIPTION OF EMBODIMENTS

Hereinafter, preferred embodiments of the present disclosure will be specifically described.

### 1. Catalyst Layer for Fuel Cell

One aspect of the present disclosure relates to a catalyst layer for a fuel cell. The catalyst layer for a fuel cell according to the present aspect includes at least of a base material, a carbon support disposed on a surface of the base material, and a catalyst metal supported on the carbon support. In the present specification, the catalyst layer for a fuel cell may be simply referred to as a catalyst layer.

In each aspect of the present disclosure, the base material constituting the catalyst layer for a fuel cell usually has a shape of a sheet or a film. The base material may be formed of a material usually used in the technical field. Examples of such a material include thermosetting resins and thermoplastic resins, particularly thermoplastic resins such as polyethylene, polypropylene, cyclic polyolefin-based resins, polyphenylene ether resins, polyethylene naphthalate-based resins (PEN), polyetherimide, polyimide, polyphenyl sulfone (PPS), polyethersulfone, or polysulfone.

In each aspect of the present disclosure, examples of the carbon support constituting the catalyst layer for a fuel cell include carbon having conductivity. The carbon support is preferably carbon black (acetylene black, ketjen black, furnace black, or the like), activated carbon, graphite, glassy carbon, graphene, carbon fiber, carbon nanotube, nitride carbon, sulfide carbon, phosphide carbon, channel black, roller black, disk black, oil furnace black, gas furnace black, lamp black, thermal black or vulcanized carbon, or a mixture of one or more of these. The carbon support is preferably carbon black.

In each aspect of the present disclosure, examples of the catalyst metal constituting the catalyst layer for a fuel cell include metals such as platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium. The catalyst metal May include the metals alone or may include two or more of the metals as an alloy. In addition, the catalyst metal may be an oxide, a nitride, a sulfide, a phosphide, or the like of the metals. The catalyst metal is preferably platinum, a platinum alloy, or a composite containing platinum, and more preferably platinum. In a case of the platinum alloy and the composite containing platinum, examples of the metal other than platinum include metals such as ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium. The platinum alloy and the composite containing platinum may include two or more types of the metals.

In each aspect of the present disclosure, the catalyst layer for a fuel cell preferably has an ionomer. The ionomer is usually disposed on a surface and voids of the carbon support. The ionomer is usually a polymer electrolyte having an ion exchange group. Examples of the ion exchange group included in the polymer electrolyte include a sulfonic acid group, a phosphoric acid group, and a quaternary ammonium cation group. Examples of the polymer constituting the polymer electrolyte include a polymer having, as a main component, perfluorocarbon, polyether ether ketone, polybenzimidazole, or the like. The ionomer is preferably a perfluorocarbon sulfonic acid polymer. As the ionomer, a commercially available product such as NAFION (trademark) manufactured by DuPont, ASI-PLIX (trademark) manufactured by Asahi Kasei Corporation, FLEMION (trademark) manufactured by Asahi Glass Co., Ltd., or GORE-SELECT (trademark) manufactured by Japan Gore-Tex, Inc. may be used.

In the catalyst layer for a fuel cell according to the present aspect, the specific surface area of the carbon support is in a range of 1,000 to 1,500 m²/g, preferably in a range of 1,000 to 1,280 m²/g, and more preferably in a range of 1,200 to 1,280 m²/g. In a case where the specific surface area of the carbon support is less than the lower limit value, the initial power generation performance may be deteriorated. In addition, in a case where the specific surface area of the carbon support exceeds the upper limit value, the carbon support is likely to be oxidized, and the power generation performance after long-term operation may be deteriorated. Therefore, the catalyst layer for a fuel cell according to the present aspect can have high power generation performance not only initially but also after long-term operation by having the carbon support having the specific surface area in the ranges.

In the catalyst layer for a fuel cell according to the present aspect, the thickness loss rate A (%) of the catalyst layer represented by the following expression (I) is 45% or less, and the deformation rate B (%) of the catalyst layer represented by the following expression (II) is 50% or less. In these cases, it was found that not only is the initial voltage of the fuel cell obtained improved, but also the decrease in voltage after the durability treatment is suppressed. The thickness loss rate A (%) of the catalyst layer is preferably in a range of 20% to 45% and more preferably in a range of 27% to 42%. The deformation rate B (%) of the catalyst layer is preferably in a range of 20% to 50% and more preferably in a range of 24% to 47%. In a case where the thickness loss rate A of the catalyst layer exceeds the upper limit value, the power generation performance after long-term operation may be deteriorated. In addition, in a case where the deformation rate B of the catalyst layer exceeds the upper limit value, the initial power generation performance may be deteriorated. Therefore, the catalyst layer for a fuel cell according to the present aspect can have high power generation performance not only initially but also after long-term operation by having the thickness loss rate A of the catalyst layer and the deformation rate B of the catalyst layer in the ranges.

$$A ( \% ) = ( 1 - {T}_{1} / {T}_{0} ) \times ( 100 ) \qquad ( I )$$

$$B ( \% ) = {D}_{i} / {T}_{0} \times 100 \qquad ( II )$$

In the expressions (I) and (II), To is an initial thickness (μm) of the catalyst layer. T₁ is a thickness (μm) of the catalyst layer after a durability treatment. Dᵢ is a deformation amount (μm) obtained as an inflection point of a load variation curve obtained by a micro-burst test of the catalyst layer.

In the catalyst layer for a fuel cell according to the present aspect, for example, a membrane electrode assembly (MEA) in which the catalyst layer is used as either or both of a cathode and an anode is produced. The durability treatment can be performed by using the MEA as a single cell and performing a steady operation at 1 to 1.5 V (for example, 1.3 V) for 1 to 5 hours (for example, 2 hours) under the following conditions. A constant (for example, 0.5/1.0 L/min) flow rate of H2/N₂ gas. A cell temperature of 70° C. to 90° C. (for example, 80° C.). An anode (hydrogen) dew point of 70° C. to 90° C. (for example, 80° C.). A cathode (air) dew point of 70° C. to 90° C. (for example, 80° C.). A back pressure of 50 to 150 kPa (absolute value) (for example, 100 kPa (absolute value)).

In the catalyst layer for a fuel cell according to the present aspect, the micro-burst test of the catalyst layer can be performed based on a method usually used in the technical field.

In the catalyst layer for a fuel cell according to the present aspect, the initial thickness T₀ of the catalyst layer is preferably in a range of 5 to 15 μm and more preferably in a range of 10 to 15 μm. The thickness T₁ of the catalyst layer after the durability treatment is preferably in a range of 5 to 10 μm and more preferably in a range of 6 to 10 μm. The deformation amount Dᵢ of the catalyst layer is preferably in a range of 2 to 8 μm and more preferably in a range of 2.4 to 8 μm.

The fact that the catalyst layer for a fuel cell according to the present aspect has high power generation performance can be evaluated, for example, by the following procedure. A MEA in which the electrode catalyst layer for a fuel cell according to the present aspect is used as either or both of a cathode and an anode is produced. The initial current-voltage characteristics of the MEA are measured by using the MEA as a single cell under the following conditions. A constant (for example, 0.5/1.0 L/min) flow rate of H2/N₂ gas. A cell temperature of 70° C. to 90° C. (for example, 80° C.). An anode (hydrogen) dew point of 70° C. to 90° C. (for example, 80° C.). A cathode (air) dew point of 70° C. to 90° C. (for example, 80° C.). A back pressure of 50 to 150 kPa (absolute value) (for example, 100 kPa (absolute value)). In addition, after the durability treatment is performed on the MEA, the current-voltage characteristics after the durability treatment are measured by the same procedure. For each MEA, the initial and after-durability treatment voltage (mV) at a high current density (2 A/cm²) is calculated.

### 2. Fuel Cell

The catalyst layer for a fuel cell according to the present aspect can be applied to both the cathode and the anode of the fuel cell. Therefore, another aspect of the present disclosure relates to a fuel cell including the catalyst layer for a fuel cell according to one aspect of the present disclosure. The fuel cell according to the present aspect includes the catalyst layer for a fuel cell according to one aspect of the present disclosure as at least one of the cathode or the anode, preferably the cathode, and further includes an electrolyte membrane and, optionally, an anode or a cathode. As materials other than the catalyst layer for a fuel cell according to one aspect of the present disclosure, the anode, the cathode, and the electrolyte membrane used in the fuel cell according to the present aspect can be appropriately selected from materials usually used in the technical field.

The fuel cell according to the present aspect can have high initial performance and can maintain high performance even after the durability treatment by applying the catalyst layer for a fuel cell according to one aspect of the present disclosure to at least one of the cathode or the anode. The fuel cell according to the present aspect can be applied to a power of a moving object such as an automobile, a railway, a ship, or an aircraft, or a power source for a household or a business. In this case, the fuel cell can stably exhibit high performance by substantially preventing a decrease in performance even in long-term use.

### 3. Method of Manufacturing Catalyst Layer for Fuel Cell and Fuel Cell

Another aspect of the present disclosure relates to a method of manufacturing a catalyst layer for a fuel cell and a fuel cell according to one aspect of the present disclosure described above. The method according to the present aspect includes a catalyst ink preparation step, a catalyst layer formation step, and a catalyst layer bonding step. In addition, the method according to the present aspect includes a material preparation step as desired. Each step will be described below.

### 3-1. Material Preparation Step

The present step includes preparing a base material, a carbon support on which a catalyst metal is supported, optionally an ionomer, and optionally an electrolyte membrane, which are used in the following steps.

The base material, the carbon support on which a catalyst metal is supported, and the ionomer prepared in the present step may be materials having the features described above. Each material may be prepared by preparing the material having predetermined features by itself, or may be prepared by purchasing a commercially available product.

### 3-2. Catalyst Ink Preparation Step

The present step includes preparing a catalyst ink containing a carbon support on which a catalyst metal is supported and optionally an ionomer.

The catalyst ink may contain a solvent in addition to the carbon support on which a catalyst metal is supported and the ionomer. The solvent is not particularly limited, and any liquid can be used. Examples of the solvent include hydrophilic solvents such as water and an alcohol, and a mixture of one or more of these. Examples of the alcohol include methanol, ethanol, 1-propanol, 2-propanol, 2-methyl-2-propanol (tert-butyl alcohol), diacetone alcohol, ethylene glycol, and propylene glycol.

In the present step, the catalyst ink is usually prepared by mixing the carbon support on which a catalyst metal is supported, the ionomer, and a solvent as desired. A mixing method for the materials is not particularly limited. Examples of the mixing method include an ultrasonic homogenizer, a beads mill, a jet mill, a ball mill, a high shear, and a Filmix. Specific conditions (for example, a stirring rate, a stirring time, a rotation speed, and the like) of the mixing method exemplified above are not particularly limited, and can be appropriately set in any range.

In the present step, it is preferable to mix the catalyst ink such that a particle size distribution (for example, D50) is a predetermined value. By adjusting the particle size distribution of the catalyst ink to a predetermined value, the catalyst layer for a fuel cell according to one aspect of the present disclosure can be formed.

### 3-3. Catalyst Layer Formation Step

The present step includes applying an electrode catalyst ink to a base material.

In the present step, a method of applying the catalyst ink to the base material is not particularly limited. Examples of the applying method include a die coating method, a spin coating method, a screen printing method, a doctor blade method, a squeegee method, a spray coating method, and an applicator method. Specific conditions of the applying method exemplified above are not particularly limited, and can be appropriately set in any range.

In the present step, the solvent may be removed from the catalyst ink after the application. The removal of the solvent is not particularly limited, and can be performed by any method such as heating and drying. Specific conditions (for example, a temperature, a pressure, and a treatment time) of the removal of the solvent are not particularly limited, and can be appropriately set in any range.

In the present step, the catalyst layer for a fuel cell according to one aspect of the present disclosure can be formed by applying the catalyst ink having the features described above to the base material.

### 3-4. Catalyst Layer Bonding Step

The present step includes bonding the catalyst layer for a fuel cell according to one aspect of the present disclosure and the electrolyte membrane.

In the present step, a method of bonding the catalyst layer and the electrolyte membrane is not particularly limited. Examples of the bonding method include a hot press method. Specific conditions of the bonding method exemplified above are not particularly limited, and can be appropriately set in any range.

In the present step, it is preferable to adjust the conditions of the bonding method such that either or both of the initial and after-durability treatment thickness of the catalyst layer is a predetermined value. For example, in a case where the bonding method is a hot press method, it is preferable to adjust the load such that either or both of the initial and after-durability treatment thickness of the catalyst layer is a predetermined value. As a result, the fuel cell according to one aspect of the present disclosure can be formed.

Hereinafter, the present disclosure will be described in greater detail with reference to embodiments. However, the technical scope of the present disclosure is not limited to the embodiments.

### I: Production of Catalyst Layer and Membrane Electrode Assembly

### I-1: Comparative Examples 1 to 8

A carbon support having a predetermined specific surface area and particle diameter, on which a catalyst metal (platinum) was supported, was mixed with ion exchange water. A hydrophilic solvent containing ethanol and 1-propanol and an ionomer (perfluorocarbon sulfonic acid polymer) were added to the mixture. The mixture was dispersed using an ultrasonic homogenizer and a beads mill to prepare a catalyst ink having a particle size distribution with a D50 of 5 μm. The catalyst ink was applied onto a base material sheet to obtain a coating layer of the catalyst ink. The coating layer was dried to obtain a catalyst layer.

The obtained catalyst layer was disposed on both surfaces of an electrolyte membrane (GORE-SELECT (trademark), manufactured by Japan Gore-Tex, Inc.) and hot-pressed at a load of 200 N/cm² for 10 minutes. An MEA having a catalyst layer of Comparative Example 1 was produced by the procedure.

### I-2: Embodiment 1

A catalyst layer and an MEA were produced by the same procedure as described above, except that in the procedure of Comparative Examples 1 to 8 described in I-1, a mixture containing the catalyst metal-supported carbon supports of Comparative Examples 1 and 2 at a mass ratio of 1:1 was used as the catalyst metal-supported carbon support.

### I-3: Embodiment 2

A catalyst layer and an MEA were produced by the same procedure as described above, except that in the procedure of Comparative Examples 1 to 8 described in I-1, a mixture containing the catalyst metal-supported carbon supports of Comparative Examples 1 and 2 at a mass ratio of 1:2 was used as the catalyst metal-supported carbon support.

### I-4: Embodiment 3

A catalyst layer and an MEA were produced by the same procedure as described above, except that in the procedure of Embodiment 1 described in I-2, the load of the hot press was changed to 1.5 times (300 N/cm²).

### I-5: Embodiment 4

A catalyst layer and an MEA were produced by the same procedure as described above, except that in the procedure of Embodiment 1 described in I-2, the dispersion time by the beads mill was Embodiment such that the D50 was doubled (10 μm).

### I-6: Embodiment 5

A catalyst layer and an MEA were produced by the same procedure as described above, except that in the procedure of Comparative Examples 1 to 8 described in I-1, a mixture containing the catalyst metal-supported carbon supports of Comparative Examples 3 and 4 at a mass ratio of 1:1 was used as the catalyst metal-supported carbon support.

### I-7: Embodiment 6

A catalyst layer and an MEA were produced by the same procedure as described above, except that in the procedure of Comparative Examples 1 to 8 described in I-1, a mixture containing the catalyst metal-supported carbon supports of Comparative Examples 3 and 4 at a mass ratio of 1:2 was used as the catalyst metal-supported carbon support.

### I-8: Embodiment 7

A catalyst layer and an MEA were produced by the same procedure as described above, except that in the procedure of Embodiment 5 described in I-6, the load of the hot press was changed to 1.5 times (300 N/cm²).

### I-9: Embodiment 8

A catalyst layer and an MEA were produced by the same procedure as described above, except that in the procedure of Embodiment 5 described in I-6, the dispersion time by the beads mill was extended such that the D50 was doubled (10 μm).

### II: Evaluation of Catalyst Layer

### II-1: Durability Treatment

The durability treatment was performed by using the MEA produced by the procedure as a single cell and performing a steady operation at 1.3 V for 2 hours under the following conditions. A flow rate of H2/N₂ gas of 0.5/1.0 L/min. A cell temperature of 80° C. An anode (hydrogen) dew point of 80° C. A cathode (air) dew point of 80° C. A back pressure of 100 kPa (absolute value).

### II-2: Thickness Loss Rate of Catalyst Layer

The initial thickness T₀ (μm) of the catalyst layer produced by the procedure and the thickness T₁ (μm) of the catalyst layer after the durability treatment after the durability treatment by the procedure of II-1 were measured. Based on T₀ and T₁, the thickness loss rate A (%) of the catalyst layer represented by the following expression (I) was calculated.

$$A ( \% ) = ( 1 - {T}_{1} / {T}_{0} ) \times ( 100 ) \qquad ( I )$$

### II-3: Deformation Rate of Catalyst Layer

A micro-burst test of the catalyst layer produced by the procedure was performed to obtain a load variation curve. In the obtained load variation curve, a deformation amount Dᵢ (μm) was obtained as an inflection point of plastic deformation. Based on T₀ and Dᵢ, the deformation rate B (%) of the catalyst layer represented by the following expression (II) was calculated.

$$B ( \% ) = {D}_{i} / {T}_{0} \times 100 \qquad ( II )$$

### II-4: Power Generation Performance Evaluation Test

The MEA produced by the procedure was used as an initial single cell, and the durability treatment was performed by the procedure of II-1. The current-voltage characteristics were measured by using each of the MEAs as a single cell after the durability treatment under the following conditions. A flow rate of H2/N₂ gas of 0.5/1.0 L/min. A cell temperature of 80° C. An anode (hydrogen) dew point of 80° C. A cathode (air) dew point of 80° C. A back pressure of 100 kPa (absolute value). For each MEA, the initial and after-durability treatment voltage (mV) at a high current density (2 A/cm²) was calculated.

Table 1 shows the features of the catalyst layers and the MEAs of Comparative Examples 1 to 8 and Embodiments 1 to 8.

TABLE 1

| | | | | | | Catalyst | | | |
|---|---|---|---|---|---|---|---|---|---|
| | Carbon | Carbon | | | Initial | layer | | | |
| | support | support | | Void ratio | catalyst | thickness | Deformation | Thickness | Deformation |
| | specific | particle | | (%) after | layer | (μm) after | amount of | loss rate of | rate of |
| Comparative | surface | diameter | Initial void | durability | thickness | durability | catalyst | catalyst | catalyst |
| Example | area (m²/g) | (nm) | ratio (%) | treatment | (μm) | treatment | layer (μm) | layer (%) | layer (%) |
| Comparative | 1280 | 99 | 40 | 7 | 11 | 2.1 | 2.8 | 81 | 25 |
| Example 1 | | | | | | | | | |
| Comparative | 1280 | 503 | 25 | 12 | 10 | 8.3 | 7.5 | 17 | 75 |
| Example 2 | | | | | | | | | |
| Comparative | 1000 | 101 | 38 | 10 | 11 | 3.2 | 2.4 | 70 | 22 |
| Example 3 | | | | | | | | | |
| Comparative | 1000 | 502 | 37 | 13 | 10 | 8.7 | 7.4 | 15 | 74 |
| Example 4 | | | | | | | | | |
| Comparative | 800 | 99 | 40 | 15 | 10 | 5.6 | 5.1 | 45 | 51 |
| Example 5 | | | | | | | | | |
| Comparative | 400 | 51 | 38 | 20 | 8.1 | 6 | 6.7 | 25 | 83 |
| Example 6 | | | | | | | | | |
| Comparative | 1200 | 99 | 40 | 15 | 10 | 7.1 | 8.6 | 29 | 86 |
| Example 7 | | | | | | | | | |
| Comparative | 1000 | 101 | 40 | 15 | 10 | 7.5 | 8 | 25 | 80 |
| Example 8 | | | | | | | | | |
| | | | | | | Catalyst | | | |
| | Carbon | Carbon | | | Initial | layer | Catalyst | | |
| | support | support | | Void ratio | catalyst | thickness | layer | Thickness | Deformation |
| | specific | particle | | (%) after | layer | (μm) after | deformation | loss rate of | rate of |
| | surface | diameter | Initial void | durability | thickness | durability | amount | catalyst | catalyst |
| | area (m²/g) | (nm) | ratio (%) | treatment | (μm) | treatment | (μm) | layer (%) | layer (%) |
| Embodiment | 1280 | 99 and | 35 | 20 | 11 | 6.4 | 4.5 | 42 | 41 |
| 1 | | 503 | | | | | | | |
| Embodiment | 1280 | 99 and | 30 | 18 | 11 | 7.5 | 5.2 | 32 | 47 |
| 2 | | 503 | | | | | | | |
| Embodiment | 1280 | 99 and | 40 | 23 | 10 | 6 | 2.5 | 40 | 25 |
| 3 | | 503 | | | | | | | |
| Embodiment | 1280 | 99 and | 43 | 25 | 10 | 6.2 | 3.9 | 38 | 39 |
| 4 | | 503 | | | | | | | |
| Embodiment | 1000 | 101 and | 35 | 21 | 11 | 6.8 | 4.8 | 38 | 44 |
| 5 | | 502 | | | | | | | |
| Embodiment | 1000 | 101 and | 30 | 19 | 11 | 8 | 3.9 | 27 | 35 |
| 6 | | 502 | | | | | | | |
| Embodiment | 1000 | 101 and | 40 | 25 | 10 | 6.2 | 2.4 | 38 | 24 |
| 7 | | 502 | | | | | | | |
| Embodiment | 1000 | 101 and | 43 | 25 | 10 | 6.5 | 4.5 | 35 | 45 |
| 8 | | 502 | | | | | | | |

Table 2 shows the initial and after-durability treatment voltage of the MEAs of Comparative Examples 1 to 8 and Embodiments 1 to 8 at a high current density.

TABLE 2

| | | Voltage value (mV) |
|---|---|---|
| | Initial voltage | after durability |
| | value (mV) | treatment |
| Comparative | 662 | 150 |
| Example 1 | | |
| Comparative | 400 | 351 |
| Example 2 | | |
| Comparative | 566 | 180 |
| Example 3 | | |
| Comparative | 382 | 341 |
| Example 4 | | |
| Comparative | 420 | 195 |
| Example 5 | | |
| Comparative | 351 | 330 |
| Example 6 | | |
| Comparative | 662 | 248 |
| Example 7 | | |
| Comparative | 660 | 246 |
| Example 8 | | |
| Embodiment 1 | 621 | 355 |
| Embodiment 2 | 511 | 337 |
| Embodiment 3 | 601 | 375 |
| Embodiment 4 | 610 | 385 |
| Embodiment 5 | 511 | 337 |
| Embodiment 6 | 520 | 329 |
| Embodiment 7 | 490 | 336 |
| Embodiment 8 | 510 | 327 |

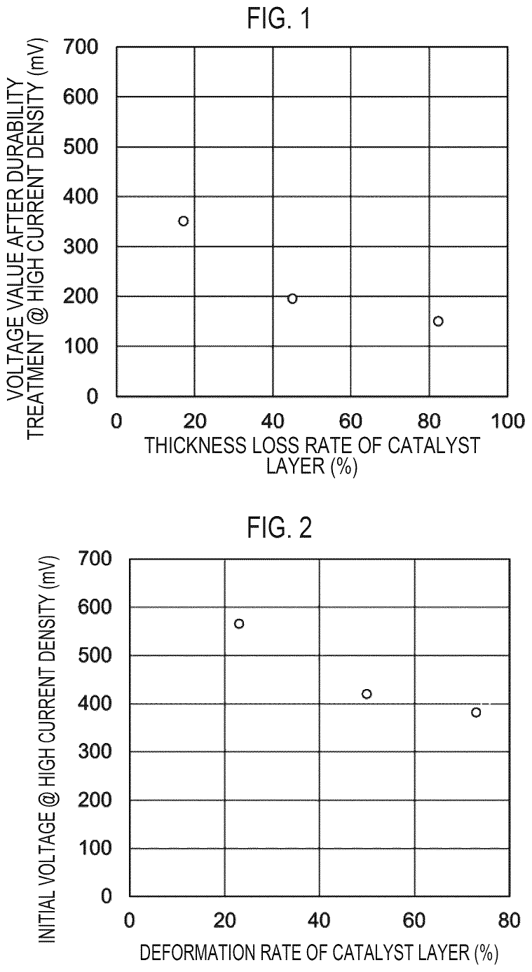

FIG. 1 shows a relationship between the thickness loss rate of the catalyst layer of Comparative Examples 1, 2, and 5 and the voltage of the MEA having the catalyst layer after the durability treatment at a high current density. In FIG. 1, the horizontal axis represents the thickness loss rate (%) of the catalyst layer, and the vertical axis represents the voltage (mV) after the durability treatment at a high current density (2 A/cm²). As shown in FIG. 1, the lower the thickness loss rate of the catalyst layer, the higher the voltage of the MEA having the catalyst layer after the durability treatment at a high current density.

FIG. 2 shows a relationship between the deformation rate of the catalyst layer of Comparative Examples 3, 4, and 5 and the initial voltage of the MEA having the catalyst layer at a high current density. In FIG. 2, the horizontal axis represents the deformation rate (%) of the catalyst layer, and the vertical axis represents the initial voltage (mV) at a high current density (2 A/cm²). As shown in FIG. 2, the lower the deformation rate of the catalyst layer, the higher the initial voltage of the MEA having the catalyst layer at a high current density.

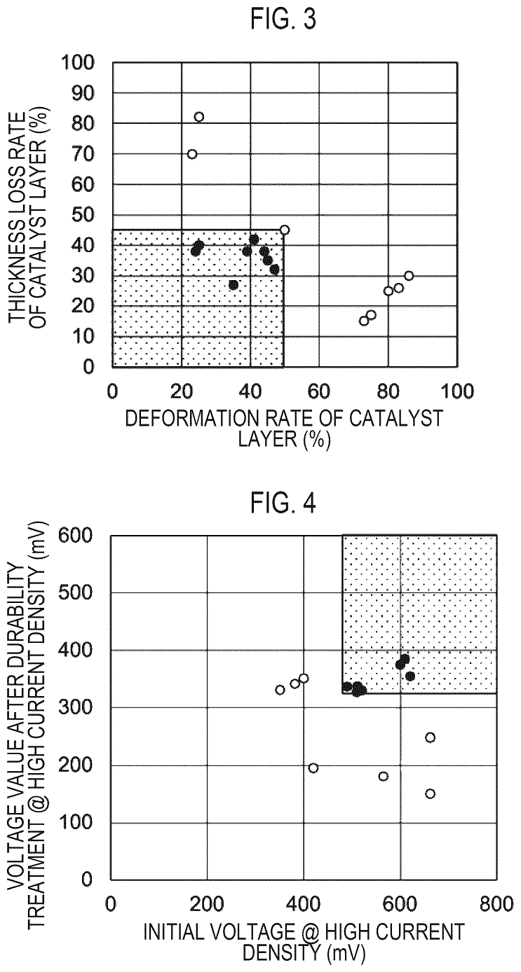

FIG. 3 shows a relationship between the deformation rate and the thickness loss rate of the catalyst layer of Comparative Examples 1 to 8 and Embodiments 1 to 8. In FIG. 3, the horizontal axis represents the deformation rate (%) of the catalyst layer, and the vertical axis represents the thickness loss rate (%) of the catalyst layer. In addition, FIG. 4 shows a relationship between the initial voltage and the voltage after the durability treatment at a high current density of the MEA having the catalyst layer of Comparative Examples 1 to 8 and Embodiments 1 to 8 at a high current density. In the figure, the horizontal axis represents the initial voltage (mV) at a high current density (2 A/cm²), and the vertical axis represents the voltage (mV) after the durability treatment at a high current density (2 A/cm²). In FIGS. 3 and 4, black-filled circular data points represent the catalyst layers of Embodiments 1 to 8, and white-filled circular data points represent the catalyst layers of

### Comparative Examples 1 to 8

As shown in FIGS. 3 and 4, in the catalyst layers of Embodiments 1 to 8, the specific surface area of the carbon support is in a range of 1,000 to 1,500 m²/g, the thickness loss rate of the catalyst layer is in a range of 45% or less, and the deformation rate of the catalyst layer is in a range of 50% or less. In the catalyst layers of Embodiments 1 to 8, both the initial voltage and the voltage after the durability treatment were high values as compared with the catalyst layers of Comparative Examples 1 to 8. In the catalyst layers of Comparative Examples 1 to 8, at least any one of the specific surface area of the carbon support, the thickness loss rate of the catalyst layer, or the deformation rate of the catalyst layer is out of the ranges. As a result, it was found that the catalyst layer of the embodiment having the features can achieve both the initial and after-durability treatment power generation performance.

The present disclosure is not limited to the Embodiments, and various Modifications are included. For example, the Embodiments are described in detail in order to easily understand the present disclosure, and are not necessarily limited to those including all the configurations described above. In addition, a part of the configuration of each Embodiment can be added, deleted, and/or replaced with another configuration.

What is claimed is:

1. A catalyst layer for a fuel cell, the catalyst layer comprising at least:
a base material;
a carbon support disposed on a surface of the base material; and
a catalyst metal supported on the carbon support, wherein:
a specific surface area of the carbon support is in a range of 1000 m²/g to 1500 m²/g;
a thickness loss rate A (%) of the catalyst layer represented by the following expression (I) is 45% or less; and
a deformation rate B (%) of the catalyst layer represented by the following expression (II) is 50% or less,
$$A ( \% ) = ( 1 - {T}_{1} / {T}_{0} ) \times 100 \qquad ( I )$$
$$B ( \% ) = {D}_{i} / {T}_{0} \times 100 \qquad ( II )$$
in the expression (I) and the expression (II),
T₀ is an initial thickness (μm) of the catalyst layer,
T₁ is a thickness (μm) of the catalyst layer after a durability treatment,
Dᵢ is a deformation amount (μm) obtained as an inflection point of a load variation curve obtained by a micro-burst test of the catalyst layer, and
the durability treatment is performed by producing a membrane electrode assembly in which the catalyst layer is used as either or both of a cathode and an anode, and performing, using the membrane electrode assembly as a single cell, a steady operation at 1 V to 1.5 V for 1 hour to 5 hours under conditions of a constant flow rate of H2/N₂ gas, a cell temperature of 70° C. to 90° C., an anode (hydrogen) dew point of 70° C. to 90° C., a cathode (air) dew point of 70° C. to 90° C., and a back pressure of 50 kPa to 150 kPa (absolute value).

2. The catalyst layer according to claim 1, wherein the thickness loss rate A (%) of the catalyst layer is in a range of 20% to 45%.

3. The catalyst layer according to claim 1, wherein the deformation rate B (%) of the catalyst layer is in a range of 20% to 50%.

4. The catalyst layer according to claim 1, wherein the thickness loss rate A (%) of the catalyst layer is in a range of 27% to 42%, and the deformation rate B (%) of the catalyst layer is in a range of 24% to 47%.

5. The catalyst layer according to claim 1, wherein the specific surface area of the carbon support is in a range of 1000 m²/g to 1280 m²/g.
